(19) United States
(12) Patent Application Publication
(10) Pub. No.: US 2011/0062359 A1
(43) Pub. Date: Mar. 17, 2011

(54) System of Controlling Fluid Flow

(75) Inventors: Rami A. Zelikovich, Tel Aviv (IL); David Arlinsky, Atlit (IL); Eyal Paz, Tel Aviv (IL)

(73) Assignee: Miss Yona Admon, Ramat Gan (IL)

(21) Appl. No.: 12/877,125

(22) Filed: Sep. 8, 2010

Related U.S. Application Data
(60) Provisional application No. 61/241,908, filed on Sep. 13, 2009.

(51) Int. Cl. F16K 31/08; F16K 31/02

(52) U.S. Cl. 251/129.04

(57) ABSTRACT

A system for controlling a fluid flow includes a remote controlled fluid valve and a pedal unit. The remote controlled fluid valve includes a RCFV PCB configured to receive electromagnetic transmissions, a gear, an arms mechanism, flexible tube, and an engine for set in rotational motion the gear, wherein the rotational motion is transformed to linear motion by the arms mechanism, for pressing on the flexible tube and thus blocking the flexible tube to a fluid flow. The pedal unit includes a tact switch, and a PU PCB, wherein when the tact switch is pressed, the PU PCB is transmitting electromagnetic command signal, wherein the electromagnetic command signal is compatible with the electromagnetic transmissions. An additional option for operation of the remote controlled fluid valves is by means of a ray cut operating system, which also includes a ray transmitter, and a ray receiver and communication transmitter.

### REFERENCE TO CROSS-RELATED APPLICATION

This application claims priority from U.S. Provisional Application No. 61/241,908, filed on Sep. 13, 2009, herein incorporated by reference in its entirety.

### FIELD OF THE INVENTION

The present invention relates to faucets, more particularly, to a system for controlling fluid flow.

### BACKGROUND OF THE INVENTION

A faucet (also known as tap, spigot and others), is a valve controlling release of fluids. FIG. 1 of the prior art illustrates a faucet having a screw-down mechanism 100, having a screw-down mechanism 11 and a faucet interior valve mechanism 12, a part of whose side has been removed to show its content.

Screw-down mechanisms have been in use since the 19^{th} century. They enable prevention of the flow of fluids, as well as regulation of quantities, and are very commonly in use, particularly in water supply systems.

In residential buildings, the use of faucets having a lever 101, (will be shown in following illustrations), is more common nowadays. Some faucets even rely on regulation which occurs earlier on in the pipeline, namely are faucets having no interior valve mechanism 12, (will be shown in following illustrations).

However, there are several drawbacks to use of a screw-down mechanism 11 and of lever-operated faucets, one example is the hygiene problem caused by the physical contact between users and levers in lavatories. One common solution for this problem is the use of a proximity sensor for activating and deactivating the faucet according to user presence or absence in the proximity of the faucet, instead of a lever.

Such a device fails to meet the demand for continuous flow without the presence of a person, such as in the case of filling water containers, when the user wishes to start the flow of water, go do something else, and come back to stop the flow.

Another drawback is that due to the inconvenience of turning the lever or the screw on and off, some users avoid turning off a faucet during intermittent use. This results in considerable waste of water.

Furthermore, some users may forget to turn off a faucet, which also results in significant waste of water. In the event a potentially dangerous liquid is involved in the faucet operation, this could end in disaster.

A remote controlled faucet is described in U.S. Pat. No. 5,226,629 to Millman et al., which is incorporated by reference for all purposes as if fully set forth herein.

The remote controlled valve assembly, of Millman et al., is attachable to a nozzle of the faucet. The valve assembly includes a battery-powered motor-driven valve member and a radio receiving unit for actuating the motor in response to signals received from a remote sending unit. The sending unit is operated by the action of the user's foot for providing “hands-free” control of the faucet. In an alternative embodiment, the valve assembly is used to remotely control independent hot and cold water faucet supply lines to regulate water temperature and pressure.

FIG. 2a of the prior art is a perspective view exploded illustration of a faucet having a lever 101a, having a lever 13, having a prior art valve assembly 200 incorporating a radio receiving unit, according to U.S. Pat. No. 5,226,629.

The prior art valve assembly 200 connects to nozzle 14, which is at the tip of the spout 15 of the faucet having a lever 101a. The prior art valve assembly 200 enables remote control of the supply through it by reception of wireless command and control signals. Operation can be done by means of pre-adjustment of the lever 13 position, followed by determining whether or not there is any flow through the prior art valve assembly 200.

FIG. 2b of the prior art is a perspective of an alternative embodiment of a faucet, according to U.S. Pat. No. 5,226,629.

The faucet having double valve mechanisms 101b, showing and two faucets having a screw-down mechanism 100, and two remote controlled prior art valve assemblies 200, each incorporating receiving units and installed on respective hot and cold water faucet supply lines 16, according to U.S. Pat. No. 5,226,629.

FIG. 2c of the prior art is a sectional view scale of the prior art valve assembly 200, coupled to a discharge opening of a faucet, according to U.S. Pat. No. 5,226,629.

The external shape of prior art valve assembly 200 is cubed, and when it connects to a supply line or to a faucet, it mostly protrudes from the flow line, and its corners pose a physical hazard, seeing as they could wound any person who runs into them in any way.

FIG. 2d of the prior art is an elevational view in section illustrating a prior art foot-operated sending unit 300, according to U.S. Pat. No. 5,226,629.

The prior art foot-operated sending unit 300 is operated by foot treading upon it, and sends command and control signals to the prior art valve assembly 200.

One advantage of the present invention is providing a remote controlled fluid valve which overcomes the above-mentioned and other drawbacks of the prior art.

Other advantages of the invention will become apparent as the description proceeds.

### SUMMARY OF THE INVENTION

The present invention is designated to solve hygienic, operational, and safety problems and to facilitate the use of faucets. It is based on the addition of a remote controlled fluid valve to the outlet of a faucet, or to the faucet's feed line. The faucet can be one of many kinds with a mechanism for controlling flow, even to the extent of complete stop.

The remote controlled fluid valve has two states, open and closed. In the closed state, regardless to the state of the faucet, no flow is allowed through the faucet. In the open state, the flow through the faucet is regulated according to its state, if the faucet itself is not closed. It is also possible to install the remote controlled fluid valve on a feed line, or at the outlet of a faucet without any regulation mechanism, or even at the end of a pipe or hose, without any faucet whatsoever.

The command for operation of the remote controlled fluid valve is receive by wireless transmission coming from a pedal unit, which can be in any practical location, such as on the floor, for operation by a push of a foot, or on a bathroom wall, for operation by the push of a hand. An additional option for the operation of the remote controlled fluid valve is by means of transmitting wireless command signals from a system including an electromagnetic beam, any disruption of which, such as with a hand passed through it, triggers the transmission of a command signal. Use of transmission encoding enables operation of several adjacent remote controlled fluid valves.

The internal mechanism of the remote controlled fluid valve can be based on various types of mechanism, also including a mechanism that blocks flow by means of mechanical force on a flexible pipe, on a mechanism including a throttle, and on a mechanism including two valves.

According to an embodiment of the present invention there is provided a system for controlling a fluid flow including: at least one remote controlled fluid valve, the at least one remote controlled fluid valve including: a gear; an engine for setting the gear in rotational motion; a flexible tube; and an arms mechanism for pressing on the flexible tube and thus blockings the flexible tube to a fluid flow, wherein the rotational motion is transformed to linear motion by the arms mechanism.

According to an embodiment of the present invention the system for controlling a fluid flow further includes: at least one pedal unit in active communication with the remote controlled fluid valve, the at least one pedal unit including: a pedal unit printed circuit board, having a transmitter; at least one pedal unit battery; and a tact switch operatively connected to the pedal unit printed circuit board, wherein when the tact switch is pressed by a pressing tact force, the pedal unit printed circuit board is transmitting at least one electromagnetic control signal.

According to an embodiment of the present invention, the at least one pedal unit further includes: a pressure pad disposed on the tact switch; and at least one push unit for activating a push force on the pressure pad, wherein when there is no second pressing force above a predetermined value acting on the pressure pad a tact force is removed from the tact switch.

According to an embodiment of the present invention, the at least one pedal unit includes: a code transmitter, and a pedal unit microcontroller for receiving data from the tact switch and from the code transmitter, wherein the pedal unit microcontroller is operatively connected to the code transmitter and operatively connected to the pedal unit printed circuit board.

According to an embodiment of the present invention, the at least one pedal unit includes: a code transmitter, and a pedal unit microcontroller for receiving data from the tact switch, and from the code transmitter, wherein the pedal unit microcontroller is operatively connected to the code transmitter and operatively connected to the pedal unit printed circuit board.

According to an embodiment of the present invention, the gear of the at least one remote controlled fluid valve further includes: a first cogwheel; a first common pivot rigidly connected to the first cogwheel; a second worm rigidly connected to the first common pivot; a second cogwheel for receiving rotational movement from the second worm; a second common pivot rigidly connected to the second cogwheel; and a wheel rigidly connected to the second common pivot, wherein the engine has an engine pivot worm (68a) for transmitting rotational movement to the first cogwheel.

According to an embodiment of the present invention, the arms mechanism of the at least one remote controlled fluid valve further includes: a first pivot connected to the wheel; a first arm connected to the first pivot; a second pivot connected to the first arm; a second arm connected to the second pivot; a third arm connected to the second pivot; a fourth pivot connected to the third arm and a fourth arm connected to the fourth pivot and rigidly connected to the flexible tube, wherein the arms mechanism has a state of pressing against the flexible tube and a state of non-pressing against the flexible tube state.

According to an embodiment of the present invention, the at least one remote controlled fluid valve further includes: a base bridge for provides a base point for generating a third force; a third pivot connected to the base bridge and connected to the second arm; and a back assembly having a sensor for recognizing the end of a movement of the arms mechanism.

According to an embodiment of the present invention, the at least one remote controlled fluid valve further includes: a remote controlled fluid valve printed circuit board having a transceiver; a remote controlled fluid valve battery operatively connected to the remote controlled fluid valve printed circuit board; a remote controlled fluid valve battery microcontroller operatively connected to the remote controlled fluid valve battery and operatively connected to the remote controlled fluid valve printed circuit board; a remote controlled fluid valve battery driver operatively connected to the remote controlled fluid valve battery microcontroller and operatively connected to the engine; and a code transceiver, wherein the remote controlled fluid valve printed circuit board is adapted for receiving an electromagnetic control signal.

According to an embodiment of the present invention, the system for controlling a fluid flow of includes: at least one ray cut operating sub-system, the at least one ray cut operating sub-system includes: a ray transmitter for a continuously transmitting a ray; and a ray receiver and communication transmitter.

According to an embodiment of the present invention, the system for controlling a fluid flow includes: at least one ray cut operating sub-system, the at least one ray cut operating sub-system includes: a ray transmitter for a continuously transmitting a ray; and a ray receiver and communication transmitter, wherein, after a period of time without any reception, reception of the ray by the ray receiver and communication transmitter, causes the ray receiver and communication transmitter to transmit a signal, thus causing the arms mechanism of the remote controlled fluid valve to alternate between the state of pressing against the flexible tube, and the state of non-pressing against the flexible tube.

According to an embodiment of the present invention, the at least one remote controlled fluid valve further includes: a wall, having a form of a cylinder, and the cylinder having a longitudinal cross-section of an ellipsoid shape with both ends cut off, including no sharp ends.

According to an embodiment of the present invention, the system for controlling a fluid flow includes at least two remote controlled fluid valves.

According to another embodiment of the present invention, there is provided a system for controlling a fluid flow, including: at least one controlled fluid valve, including: a body, the body including a fluid passageway having an inlet, and an outlet; a control circuit having an antenna mounted inside the body; at least one battery mounted inside the body, the battery being operatively connected to the control circuit; an engine mounted inside the body, the engine is operatively connected to the control circuit; a central axle disposed within the passageway; a throttle mounted on the central axle inside the passageway wherein the throttle is operatively connected to the engine, wherein the throttle has an open state and a closed state; at least one ray cut operating sub-system, the at least one ray cut operating sub-system including: a ray transmitter for a continuously transmitting a ray; and a ray receiver and communication transmitter, wherein reception, after a period of time without any reception, of the ray by the ray receiver and communication transmitter causes the ray receiver and communication transmitter to transmit a signal, thus causing the throttle of the controlled fluid valve to alternate between the open state and the closed state.

According to still another embodiment of the present invention, there is provided a system for controlling a fluid flow including: at least one controlled fluid valve including: a body, the body including a passageway having a passageway inlet and a passageway outlet; a passageway opening located inside the body; a passageway valve for blocking the passageway opening, wherein the passageway valve has an open state and a closed state; a passageway opening spring in contact with the passageway valve; an inside compartment located inside the body, the inside compartment having an inside compartment space, an inside compartment inlet and an inside compartment outlet; a releasing pressure valve located inside the inside compartment; a coil located inside the inside compartment; a magnet located inside the inside compartment; a spring for releasing pressure located inside the inside compartment, wherein upon receiving a signal the releasing pressure valve moves from the inside compartment inlet, thereby allowing fluid to enter into the inside compartment, and exit through the inside compartment outlet, thus, fluid pressure on the passageway valve is reduced, thereby allowing the passageway opening spring to overcome the fluid pressure on the passageway valve thus shifting the passageway valve to open state; at least one a ray cut operating sub-system, the at least one ray cut operating sub-system including: a ray transmitter for a continuously transmitting a ray; and a ray receiver and communication transmitter, wherein reception, after a period of time without any reception, of the ray by the ray receiver and communication transmitter causes the ray receiver and communication transmitter to transmit a signal, thus causing the passageway valve of the controlled fluid valve to be in the open state.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 of the prior art illustrates a faucet having a screw-down mechanism and a faucet interior valve mechanism, a part of whose side has been removed to show its content.

FIG. 2a of the prior art is a perspective view exploded illustration of a faucet, (having a lever), having a valve assembly incorporating a radio receiving unit, according to U.S. Pat. No. 5,226,629.

FIG. 2b of the prior art is a perspective of an alternative embodiment of a faucet, according to U.S. Pat. No. 5,226,629, showing two remote controlled valve assemblies, each incorporating receiving units and installed on respective hot and cold water faucet supply lines.

FIG. 2c of the prior art is a sectional view scale of the valve assembly, coupled to a discharge opening of the faucet, according to U.S. Pat. No. 5,226,629.

FIG. 2d of the prior art is an elevational view in section illustrating a foot-operated sending unit, according to U.S. Pat. No. 5,226,629.

FIG. 3a is a perspective view schematic illustration of an exemplary, illustrative embodiment of a system for controlling a fluid flow, including three faucets, three pedals, four remote controlled fluid valves, and ray cut operating sub-system, according to the present invention.

FIG. 3b is a perspective view schematic illustration of an exemplary, illustrative embodiment of a faucet, and a pedal in a bathroom.

FIG. 4a is a perspective view schematic illustration of an exemplary, illustrative embodiment of an interior mechanism of a remote controlled fluid valve, according to the present invention.

FIG. 4b is another perspective view schematic illustration of an exemplary, illustrative embodiment of an interior mechanism of the remote controlled fluid valve, according to the present invention.

FIG. 5a is a top view schematic illustration of an exemplary, illustrative embodiment of a remote controlled fluid valve, according to the present invention, upon which the section planes a-a, and b-b are marked.

FIG. 5b is a schematic cross sectional side view a-a illustration of an exemplary, illustrative embodiment of the remote controlled fluid valve, according to the present invention.

FIG. 5c is a schematic cross sectional side view b-b illustration of an exemplary, illustrative embodiment of the remote controlled fluid valve, according to the present invention.

FIG. 5d is a schematic perspective view illustration of an exemplary, illustrative embodiment of an arms mechanism, wheel and a segment of the flexible tube in closed state, according to the present invention.

FIG. 5e is a schematic perspective view illustration of an exemplary, illustrative embodiment of the arms mechanism, wheel and a segment of the flexible tube in an open state, according to the present invention.

FIG. 6a is a top view schematic illustration of an exemplary, illustrative embodiment of a pedal unit, according to the present invention, upon which the section planes d-d, and e-e are marked.

FIG. 6b is a schematic cross sectional side view d-d illustration of an exemplary, illustrative embodiment of the pedal unit, according to the present invention.

FIG. 6c is a schematic cross sectional side view e-e illustration of an exemplary, illustrative embodiment of the pedal unit, according to the present invention.

FIG. 6d is a perspective view schematic illustration of an exemplary, illustrative embodiment of an interior mechanism of a pedal unit, according to the present invention.

FIG. 6e is another perspective view schematic illustration of an exemplary, illustrative embodiment of an interior mechanism of the pedal unit, according to the present invention.

FIG. 7 is a schematic cross sectional side view illustration of another exemplary, illustrative of embodiment of remote controlled fluid valve, according to the present invention.

FIG. 8 is a schematic cross sectional side view illustration of yet another exemplary, illustrative embodiment of remote controlled fluid valve, according to the present invention.

FIG. 9a is block diagram schematically illustrating a pedal unit, according to some embodiments of the invention.

FIG. 9b is block diagram schematically illustrating a remote controlled fluid valve, according to some embodiments of the invention.

FIG. 10 is a detailed electric circuit diagram of an exemplary embodiment of a tact switch, according to the present invention.

FIG. 11 is a detailed electric circuit diagram of an exemplary embodiment of a pedal unit, according to the present invention.

FIG. 12 is a detailed electric circuit diagram of an exemplary embodiment of a remote controlled fluid valve, according to the present invention.

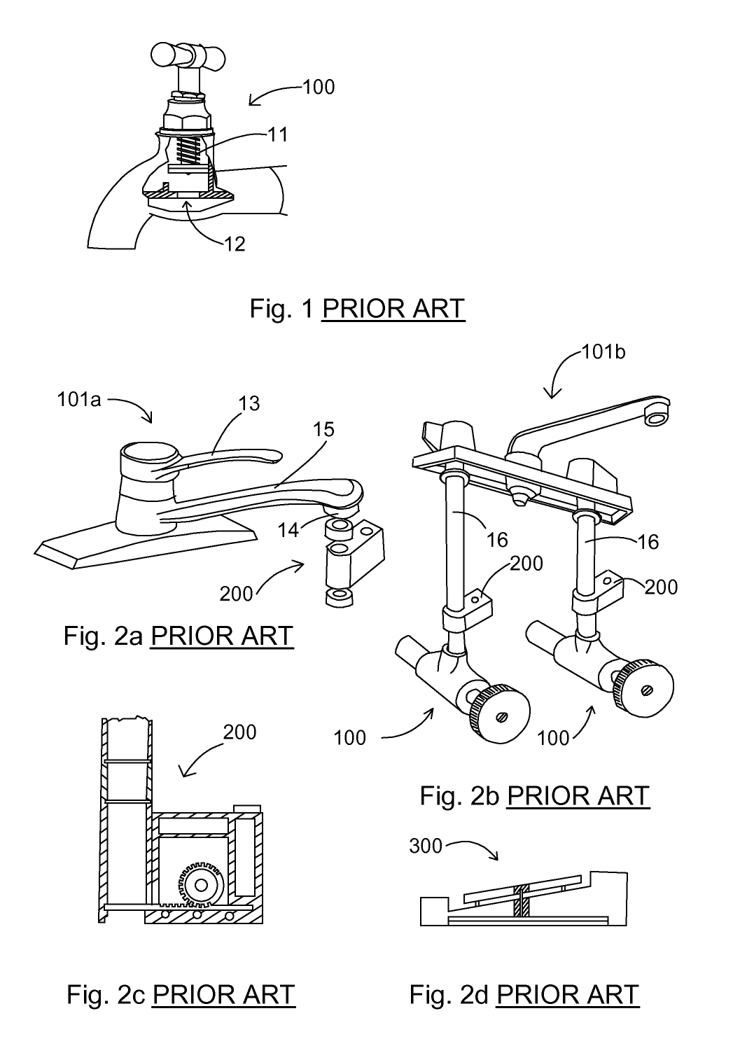

### DETAILED DESCRIPTION OF EMBODIMENTS

The present invention is of a system for controlling a fluid flow. The principles and operation of the system for controlling a fluid flow according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
11 screw-down mechanism
12 faucet interior valve mechanism
13 lever
14 nozzle
15 spout
16 faucet supply line
31 wireless communication
32a PU (pedal unit) upper wall
32b PU lower wall
33 PU PCB (pedal unit printed circuit board)
33a transmitter
34 PU battery
35 tact switch
36 push unit
37 PU microcontroller
38 pressure pad
39 code transmitter
41 ray transmitter
42 ray
43 ray receiver and communication transmitter
51 wall
52 floor
53 ceiling
54 showerhead
55 shower hose
56 bathtub
60 RCFV wall
61 flexible tube
62a first connector
62b second connector
63 RCFV PCB
63a transceiver
64 engine
65 RCFV battery
65a RCFV microcontroller
65b driver
65c on/off and weak battery indication LED
65d code
66 gear
67 wheel
68a engine pivot worm
68b first cogwheel
68c second worm
68d second cogwheel
69a first common pivot
69b second common pivot
69c first pivot
69d second pivot
69e third pivot
69f fourth pivot
70 arms mechanism
71a first arm
71b second arm
71c third arm
71d fourth arm
72 base bridge
73 back assembly
73a sensor
80 ARCFV fluid passageway
81 ARCFV body
82 ARCFV exterior thread
83 ARCFV control circuit
83a antenna
84 ARCFV battery
85i ARCFV inlet
85o ARCFV outlet
86 ARCFV engine
87 throttle
87′ rotated throttle
88 central axle
90 SARCFV passageway
91 SARCFV body
92 releasing pressure valve
92a coil
92b magnet
92c spring for releasing pressure
93 inside compartment
93b inside compartment space
93i inside compartment inlet
93o inside compartment outlet
94 passageway valve
95a passageway opening
95b passageway opening spring
95i passageway inlet
95o passageway inlet
100 faucet having a screw-down mechanism
101a faucet having a lever
101b faucet having double valve mechanisms
102 faucet having no interior valve mechanism
200 prior art valve assembly
201 remote controlled fluid valve (RCFV)
201′ interior mechanism of the remote controlled fluid valve
202 another embodiment of remote controlled fluid valve (ARCFV)
203 still another embodiment of remote controlled fluid valve (SARCFV)
300 prior art foot-operated sending unit
301 pedal unit (PU)
301′ interior mechanism of the pedal unit
401 ray cut operating sub-system
1000 system for controlling fluid flow
Fp₁ first pressing force
Fp₂ second pressing force
F₃ third force
Fs stepping force
Ft tact force
Fpu push force

Note: the element names, remote controlled fluid valve and RCFV, are interchangeable and will be used in the present application as convenient, as are the element names, pedal unit and PU.

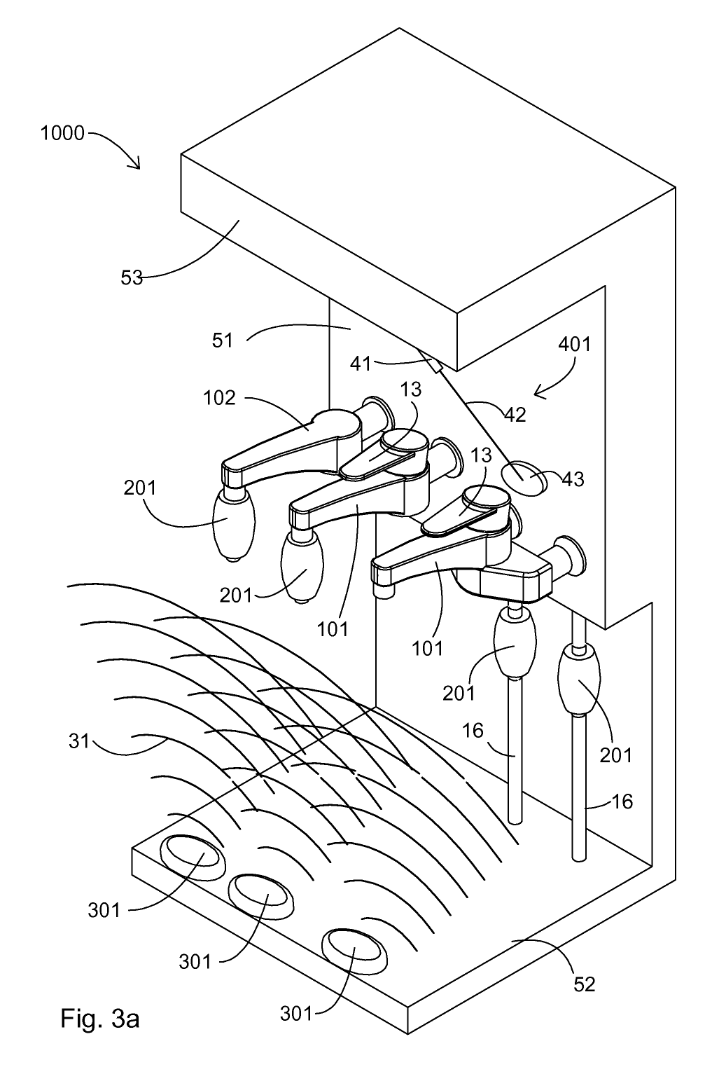

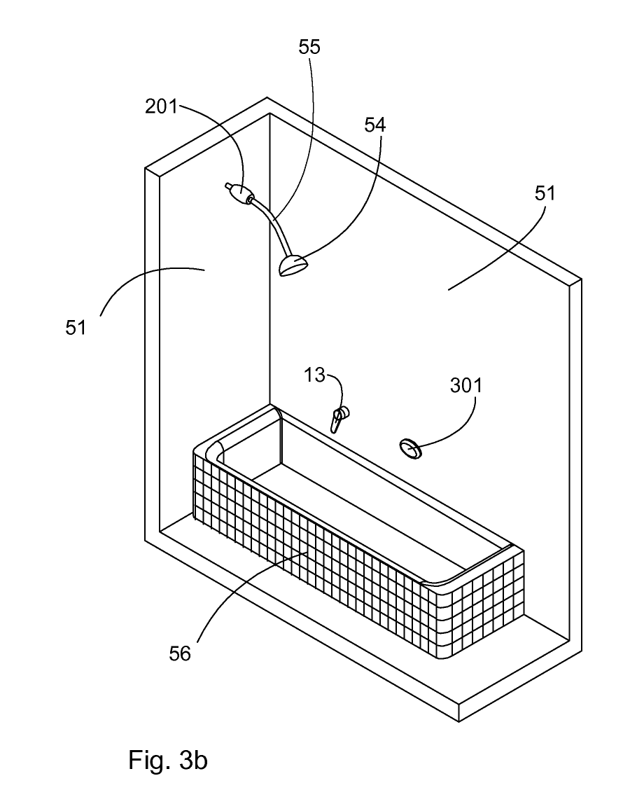

Referring now to the drawings, FIG. 3a is a perspective view schematic illustration of an exemplary, illustrative embodiment of a system for controlling a fluid flow 1000, including three faucets (two faucets having a lever 101, and one faucet having no interior valve mechanism 102, three pedal 301 units, four remote controlled fluid valves (RCFV) 201, and one ray cut operating sub-system 401, according to the present invention.

In the present illustration, all pedal units 301 are disposed on the floor 52, so that their upper parts can be activated by the press of a foot, and faucets having a lever 101 and faucets having no interior valve mechanism 102 are mounted upon a wall 51.

The remote controlled fluid valve 201 has two end states, closed state and open state. In closed state, no flow of fluids is allowed through the remote controlled fluid valve 201. In open state, the maximum capacity of fluid is allowed through the remote controlled fluid valve 201, on the condition that flow is possible through the faucet and the pipeline to which it is connected. The capacity is also determined, in the case of the present illustration of a faucet having a lever 101, by the state of the lever 13. In the case of a faucet having no interior valve mechanism 102, the capacity is maximal.

The transition from one state to another of a remote controlled fluid valve 201 occurs by one press of a specific pedal unit 301.

The pedal unit 301 communicates with a remote controlled fluid valve 201 by wireless communication 31. The pedal unit 301, when pressed, opens or closes the remote controlled fluid valve 201.

The wireless communication 31 can be an electromagnetic signal at a suitable frequency, such as RF or IR radiation etc.

The present illustration shows a remote controlled fluid valve 201 connected to an outlet of a faucet having no interior valve mechanism 102 and operated by one of the pedal units 301. Another remote controlled fluid valve 201 is connected to the outlet of a faucet having a lever 101 and is operated by another pedal unit 301. Two remote controlled fluid valves 201 are connected to two faucet supply lines 16, with one faucet having a lever 101 per line, and both operated simultaneously by one pedal unit 301. When it is necessary, as occurs in the site shown in the present illustration, to operate one specific remote controlled fluid valve 201 by means of pedal unit 301, coding can be used. One example of coding is transmitting a signal from the pedal unit 301, coded by a code transmitter 39, (not shown in the present illustration), a component including a number of bits, such as three bits, each of which is binary so that up to eight different signals can be transmitted, as shown in Table 1. Thus, eight separate transmission units can be controlled in a single space, with each remote controlled fluid valve 201 having the appropriate coding.

TABLE 1

| | | | Controlled |
|---|---|---|---|
| Bit 2 | Bit 1 | Bit 0 | unit |
| 0 | 0 | 0 | 1 |
| 0 | 0 | 1 | 2 |
| 0 | 1 | 0 | 3 |
| 0 | 1 | 1 | 4 |
| 1 | 0 | 0 | 5 |
| 1 | 0 | 1 | 6 |
| 1 | 1 | 0 | 7 |
| 1 | 1 | 1 | 8 |

It is, in cases in which the site requires encoding for larger number of options possible to use a component including more than three bits.

An additional option for operation of remote controlled fluid valves 201 is by means of a ray cut operating sub-system 401, which also includes a ray transmitter 41, which can be mounted on a ceiling 53 a underneath a cupboard, etc., and which continuously transmits a ray 42, with a ray receiver and communication transmitter 43 receiving this ray. When ray 42 is cut, for example by a hand disrupting its transmission, a signal is transmitted, similar to the signal transmitted from pedal unit 301. Thus, any such movement of a hand etc. will cause the corresponding remote controlled fluid valve 201 to change its state, alternating between open and closed.

The remote controlled fluid valves 201 and the pedal units 301 are designed to be impenetrable to fluids, by use of suitable technologies and using sealants if necessary.

The remote controlled fluid valves 201 are designed to be free of fluid leakage from the flexible tubes (61) and the respective connections of the first connector (62a) and the second connector (62b) (whether it is connected to the faucet or the faucet supply line).

The present invention is in no way limited to the type of site described in the present illustration, and is applicable in many various combinations of the components shown in the present illustration as well as additional components.

FIG. 3b is a perspective view schematic illustration of an exemplary, illustrative embodiment of a faucet, and a pedal in a bathroom. Here the pedal unit 301 is mounted on a wall 51 and can be operated by the press of a hand.

The remote controlled fluid valve 201 can be installed on the water flow line in any reasonable location, for example before the faucet having a lever 101, or between it and the showerhead 54, on the shower hose 55. If the shower hose 55 is not composed of a suitable material to bear the water pressure when in closed state, the remote controlled fluid valve 201 should be installed before it.

The illustration also shows the bathtub 56.

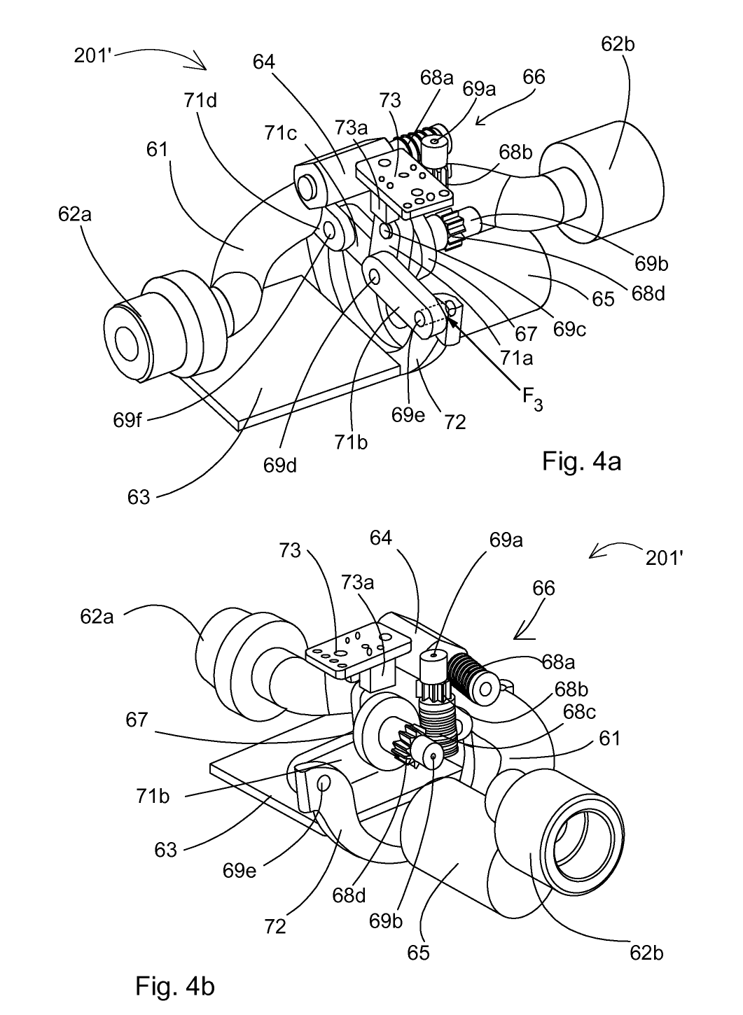

FIG. 4a is a perspective view schematic illustration of an exemplary, illustrative embodiment of an interior mechanism of the remote controlled fluid valve 201′, according to the present invention.

The function of the interior mechanism of the remote controlled fluid valve 201′ is based on the operation concept of a pinch valves, namely use of a flexible tube 61, the flow through which can be regulated or even blocked completely by minimizing the area of its internal cross section, by means of pressure or pinching it with mechanical force.

Flexible tube 61 should be composed of a flexible material which is impermeable to the fluids that are supposed to flow through it. A good material for this purpose, if the fluid is water, is silicon.

A first connector 62a is installed at one end of the flexible tube 61, and if necessary, a second connector 62b is installed at the other end.

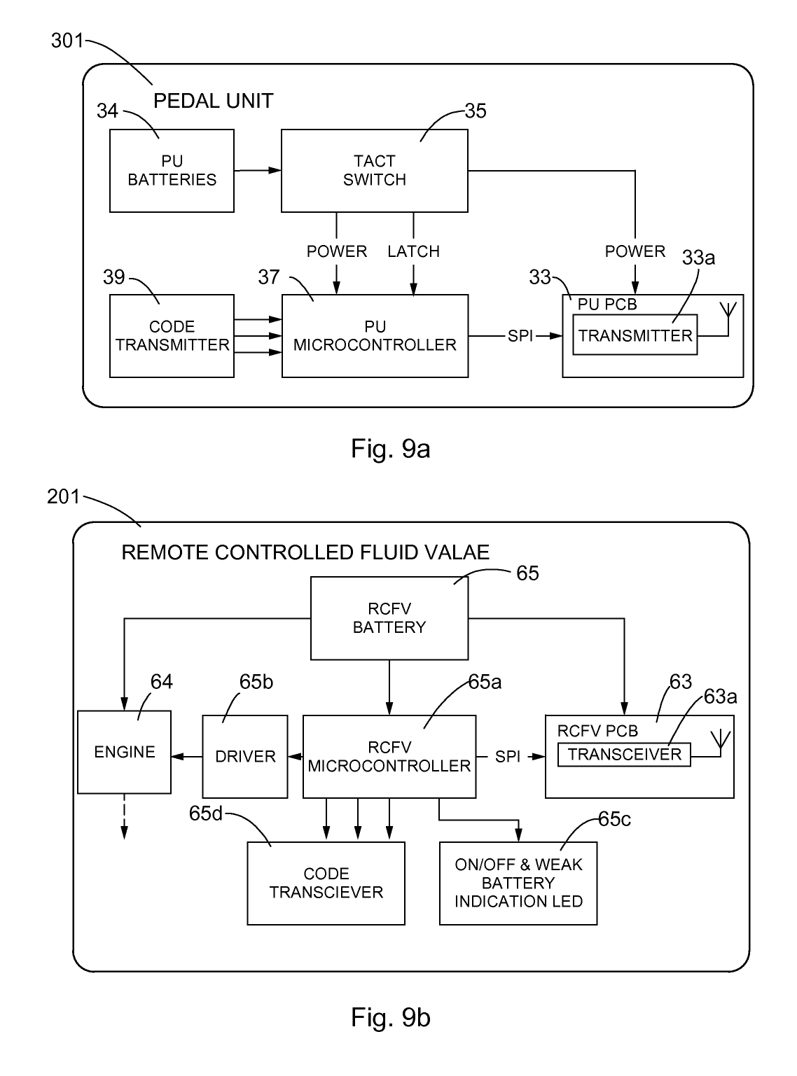

The interior mechanism of a remote controlled fluid valve 201′ receives the command signal for its operation by means of a RCFV PCB 63, which includes all components required in a transceiver 63a, (not shown in the present illustration, shown in FIG. 9b), also including an antenna. The command signals activate an engine 64. The RCFV PCB 63 and the engine 64 are fed with electrical supply from a RCFV battery 65.

Engine 64 generates rotational movement in gear 66 which is generated by means of arms to wheel 67. Thus, the multi-cycled rotational movement of the shaft of engine 64 is transmitted into only half a cycle of wheel 67, enabling the generation of sufficient power for the aforementioned pressure or pinching from a relatively small engine.

Gear 66, shown in the present illustration, also includes engine pivot worm 68a which transmits rotational movement to a first cogwheel 68b, which is rigidly connected, by means of a first common pivot 69a, to a second worm 68c, (not shown in the present illustration, shown in FIG. 4b), which generates rotational movement of a second cogwheel 68d, which is rigidly connected by means of a second common pivot 69b, to a wheel 67.

Wheel 67 is connected to one end of a first arm 71a, by means of a first pivot 69c.

The other end of first arm 71a is connected to the first ends of a second arm 71b and a third arm 71c, by means of a second pivot 69d. The other end of the second arm 71b is connected to a base bridge 72, which provides a base point for generating third force F₃, by means of a third pivot 69e.

The other end of the third arm 71c is connected to a fourth arm 71d by means of a fourth pivot 69f.

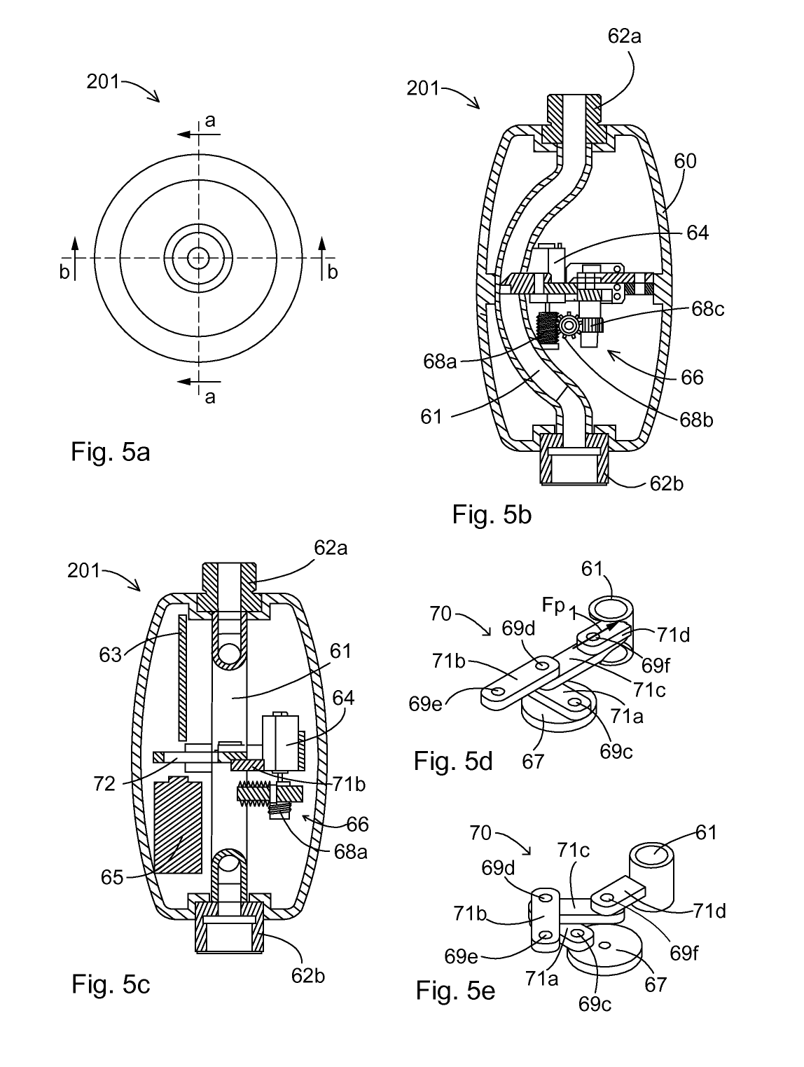

The fourth arm 71d is rigidly connected to flexible tube 61, and applies the first pressing force Fp₁ (shown in FIG. 5d), to it for the purpose of blocking the flow through it. The present illustration also shows the back assembly 73, which serves as a base for a sensor 73a, which can be an opto-electric sensor designated to recognize the end of a movement of the first arm 71a.

FIG. 4b is another perspective view schematic illustration of an exemplary, illustrative embodiment of the interior mechanism of the remote controlled fluid valve 201′, according to the present invention.

The present illustration also shows components not shown in the previous illustration.

FIG. 5a is a top view schematic illustration of an exemplary, illustrative embodiment of a remote controlled fluid valve 201, according to the present invention, upon which the section planes a-a, and b-b are marked.

FIG. 5b is a schematic cross sectional side view a-a illustration of an exemplary, illustrative embodiment of the remote controlled fluid valve 201, according to the present invention.

The external casing shape of the remote controlled fluid valve 201, according to the present invention, is a user-friendly shape, with a rounded surface with no sharp corners.

The RCFV wall 60 is shown here in a two-dimensional section, of a cylinder, which is essentially similar to an ellipsoid shape with both ends cut off. Within the RCFV wall 60, the illustration also shows the flexible tube 61 when it is up against the RCFV wall 60, or alternatively up against the wall protrusion, thus preventing any movement when it is pressed forcefully, as will be demonstrated in FIG. 5d. The illustration also shows the engine 64, and the gear 66.

FIG. 5c is a schematic cross sectional side view b-b illustration of an exemplary, illustrative embodiment of the remote controlled fluid valve 201, according to the present invention.

The present illustration also shows the engine 64, the gear 66, the RCFV PCB 63, and the base bridge 72, which serves as a base point for fourth pivot 69f, (shown in FIG. 5d).

FIG. 5d is a schematic perspective view illustration of an exemplary, illustrative embodiment of an arms mechanism 70, wheel 67 and a segment of the flexible tube 61 in closed state, according to the present invention.

Wheel 67 is such that first pivot 69c, to which the wheel is connected, is located such that it pulls the first arm 71a, which in turn pulls ends of the second arm 71b and the third arm 71c. Thus they are all along a single line, such that they create a first pressing force (Fp₁) between the base bridge 72, (not shown in the present illustration, shown in FIGS. 4a and 4b), which serves as a base point, and the fourth arm 71d, which presses against the flexible tube 61 and blocks any flow through it.

In this state, the arms mechanism 70 is mechanically locked, so that even without any force applied by engine 64, the closed state is maintained.

FIG. 5e is a schematic perspective view illustration of an exemplary, illustrative embodiment of the arms mechanism 70, wheel 67, and a segment of the flexible tube 61 in open state, according to the present invention.

In this state, wheel 67 makes half a rotation relative to the state shown in the previous illustration. As a result, the mechanical lock of the arms mechanism 70 is released. The first arm 71a pulls out the ends of the second arm 71b and the third arm 71c from their previous alignment. As a result, the fourth arm 71d is pulled, and the first pressing force (Fp₁) applied to the flexible tube 61 is released to enable an open state.

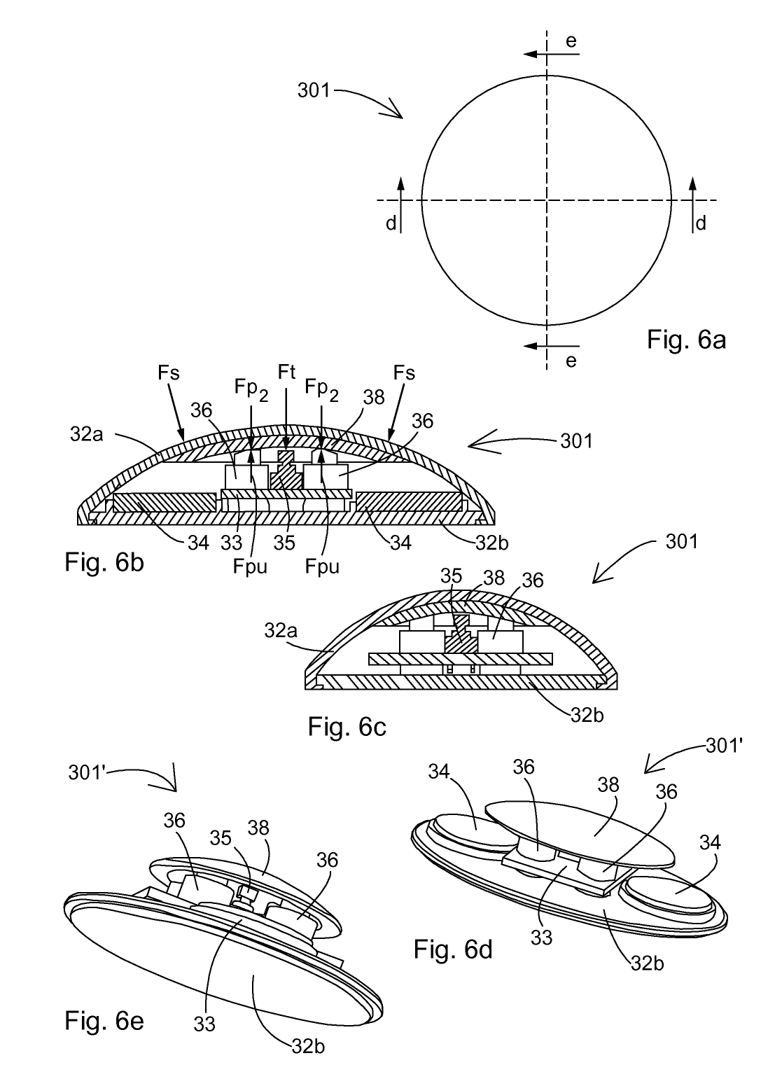

FIG. 6a is a top view schematic illustration of an exemplary, illustrative embodiment of a pedal unit 301, according to the present invention, upon which the section planes d-d, and e-e are marked.

FIG. 6b is a schematic cross sectional side view d-d illustration of an exemplary, illustrative embodiment of the pedal unit 301, according to the present invention.

Pedal unit 301 has an external casing including a PU lower wall 32b, which can connect to the upper surface of a floor, or be slightly embedded within, and a PU upper wall 32a, and is sufficiently flexible to enable any sufficiently forceful step on it to initiate transmission of a command signal.

Pressure pad 38 is disposed underneath PU upper wall 32a, can be dome shaped, and transmits the stepping force Fs from the PU upper wall 32a to a tact switch 35.

Push units 36 activate push forces (Fpu) on the bottom of pressure pad 38, so that if the second pressing force (Fp₂) of the stepping foot is released, a tact force (Ft), is removed from the tact switch 35. The tact switch 35 has two states, closed and open. When it is closed, its enables the PU PCB 33 to transmit control signals.

PU PCB 33 includes a transmitter 33a, (not shown in the present illustration, shown in FIG. 9a) and all the necessary components for generating and transmitting command signals, including a transmission antenna.

PU PCB 33 receives electrical power from PU battery 34.

FIG. 6c is a schematic cross sectional side view e-e illustration of an exemplary, illustrative embodiment of the pedal unit 301, according to the present invention.

FIG. 6d is a perspective view schematic illustration of an exemplary, illustrative embodiment of an interior mechanism of the pedal unit 301′, according to the present invention.

FIG. 6e is another perspective view schematic illustration of an exemplary, illustrative embodiment of an interior mechanism of the pedal unit 301′, according to the present invention.

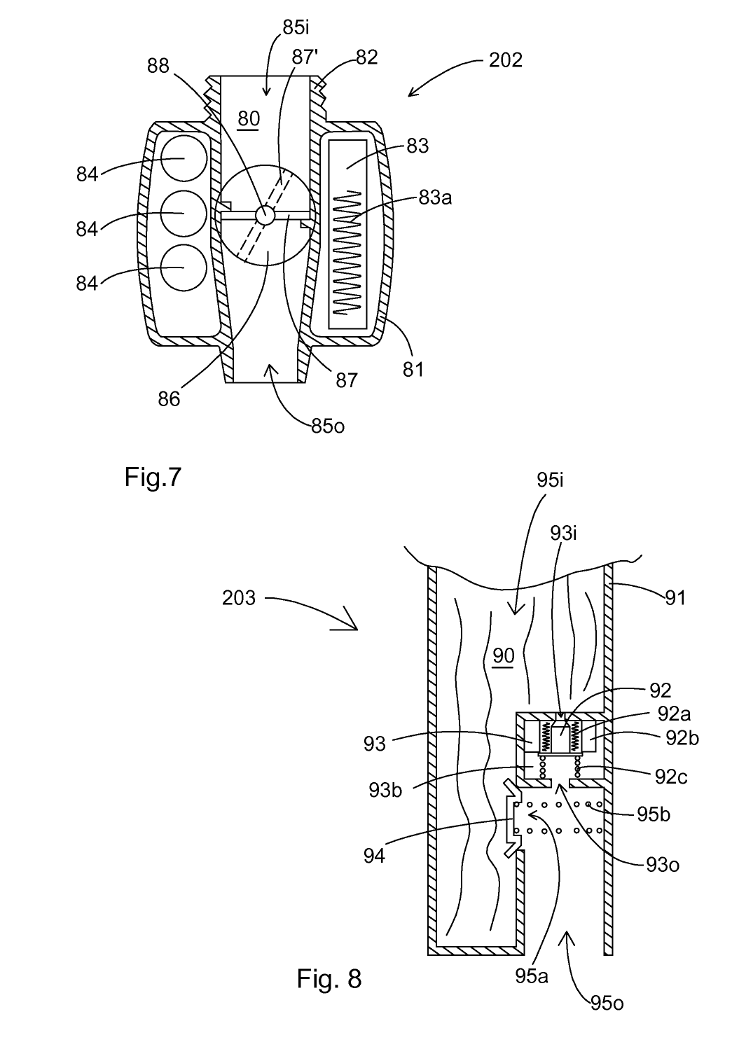

FIG. 7 is a schematic cross sectional side view illustration of an exemplary, illustrative of another embodiment of remote controlled fluid valve, (ARCFV) 202, according to the present invention.

The another embodiment of remote controlled fluid valve 202 comprises a ARCFV exterior thread 82, through which it can be connected to a spout of a faucet, which has internal screw threading suitable for an ARCFV body 81.

The another embodiment of remote controlled fluid valve 202 can also be equipped with other types of connectors and be suitable for connection to a faucet supply line.

Water enters into the fluid passageway ARCFV 80 through inlet ARCFV 85i, and exits the unit through ARCFV outlet 85o. In ARCFV fluid passageway 80, a throttle 87 is installed, which rotates around a central axle 88. The throttle 87 is operated by electric ARCFV engine 86, which uses the power of ARCFV batteries 84.

In the illustration, throttle 87 is described in solid and dashed lines. The solid line illustrates the throttle 87 in a situation wherein the fluid ARCFV passageway 80 is blocked, namely in a closed state. The dashed line illustrates the throttle 87′ in a state wherein the fluid ARCFV passageway 80 is unblocked, namely in an open state.

The rotation between both states is around a central axle 88.

An ARCFV control circuit 83 is an electronic card containing all necessary components to receive electromagnetic command signals, also including the antenna 83a.

FIG. 8 is a schematic cross sectional side view illustration of an exemplary, illustrative of still another embodiment of remote controlled fluid valve, (SARCFV) 203, according to the present invention.

The structure of the SARCFV 203 includes SARCFV passageway 90 which is within SARCFV body 91.

Fluid enters into the fluid passageway SARCFV passageway 90 through passageway inlet 95i, and exits the unit through passageway inlet 95o.

The SARCFV body 91 also contains a releasing pressure valve 92, a passageway valve 94, and other components required for their activation, as well as a coil 92a, a magnet 92b, a spring for releasing pressure 92c and an inside compartment space 93b.

The state shown in the present illustration is in a closed state, the SARCFV passageway 90 is blocked by the passageway valve 94.

In the closed state, the fluid pressure on the passageway valve 94 overcomes the power of passageway opening spring 95b, thereby keeping the SARCFV passageway 90 blocked. However, upon decreasing the fluid pressure on the SARCFV fluid passageway valve 94, the passageway opening 95a opens, thus opening the flow of fluid through the SARCFV passageway 90.

The pressure level of the fluid on the SARCFV passageway valve 94 can be reduced as follows:

An inside compartment 93 is installed inside the SARCFV passageway 90. Upon receiving a signal (such as from a foot pedal unit), a releasing pressure valve 92 moves from inside compartment inlet 93i, thereby allowing fluid to enter into compartment 93, and exit through an inside compartment outlet 93o. Thus, the fluid pressure on the left side of the passageway valve 94 is reduced, thereby allowing a passageway opening spring 95b to overcome the fluid pressure on the passageway valve 94, thus shifting to open state.

Thus, compartment 93 and the components thereof are actually a fluid trigger operable to decrease/increase the fluid pressure in the SARCFV passageway 90. When the hydraulic trigger decreases hydraulic pressure inside the SARCFV passageway 90, the passageway valve 94 unblocks the flow and vice versa.

This embodiment is beneficial over the embodiment of FIG. 7, since the electrical power required to open the block and unblock the fluid passageway is significantly smaller thanks to the action of the fluid trigger, which after being triggered, employs the fluid pressure as a substitute for electrical power.

In a simplified embodiment, when a user presses the pedal, the fluid passageway opens, closes. This requires a relatively simple circuitry.

In a more complicated embodiment, the user may select an operational state by different signaling, such as the double click in a computer mouse. This requires more sophisticated circuitry.

FIG. 9a is block diagram schematically illustrating a pedal unit 301, according to some embodiments of the invention.

The block diagram of the pedal unit 301 shows that the PU battery or batteries 34 electrically feed the tact switch 35 and effectively all electrical components of the pedal unit 301. The PU microcontroller 37 receives data regarding power and latch from the tact switch 35.

The PU microcontroller 37 also receives data from a code transmitter 39 which in turn passes on data to the PU PCB 33.

FIG. 9b is block diagram schematically illustrating a remote controlled fluid valve 201, according to some embodiments of the invention.

The block diagram of the remote controlled fluid valve 201 shows that the RCFV battery 65 electrically feeds the engine 64, the RCFV microcontroller 65a, and the RCFV PCB 63, and actually, all electronic components of the remote controlled fluid valve 201.

The RCFV PCB 63 includes a transceiver 63a and all the necessary components for receiving command signals, including a receiving antenna.

The RCFV microcontroller 65a also transmits data to an on/off and weak battery indication LED 65c, and to a driver 65b.

Driver 65b activates engine 64 which activates gear 66, (not shown in the present illustration), which in turn activates the arms mechanism 70, (not shown in the present illustration), thus determining the open or closed state of the flexible tube 61 (not shown in the present illustration).

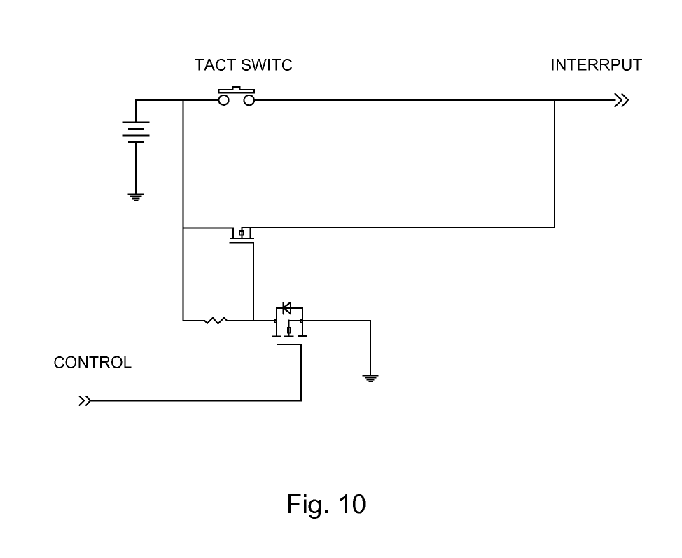

FIG. 10 is a detailed electric circuit diagram of an exemplary embodiment of a tact switch, according to the present invention.

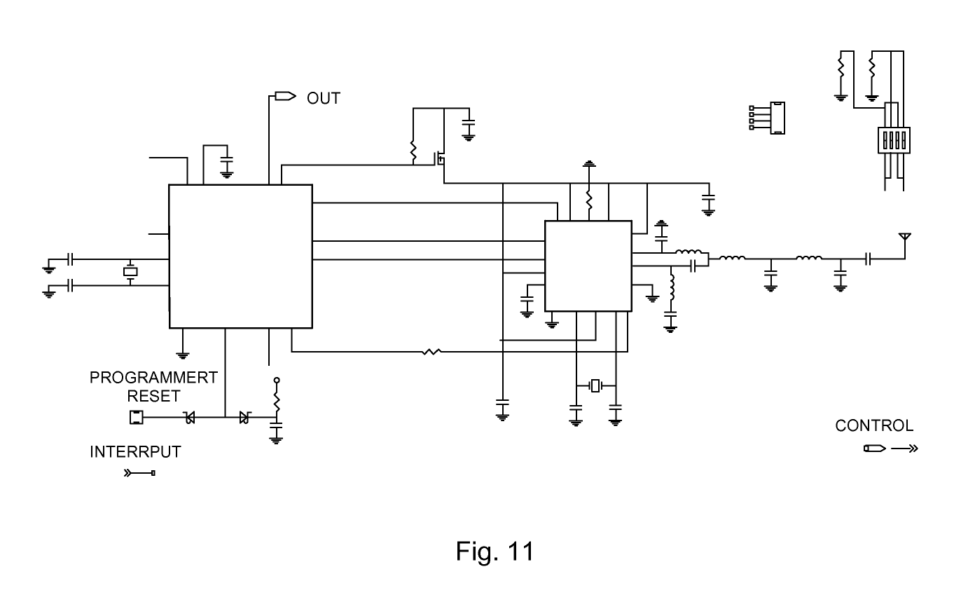

FIG. 11 is a detailed electric circuit diagram of an exemplary embodiment of a pedal unit, according to the present invention.

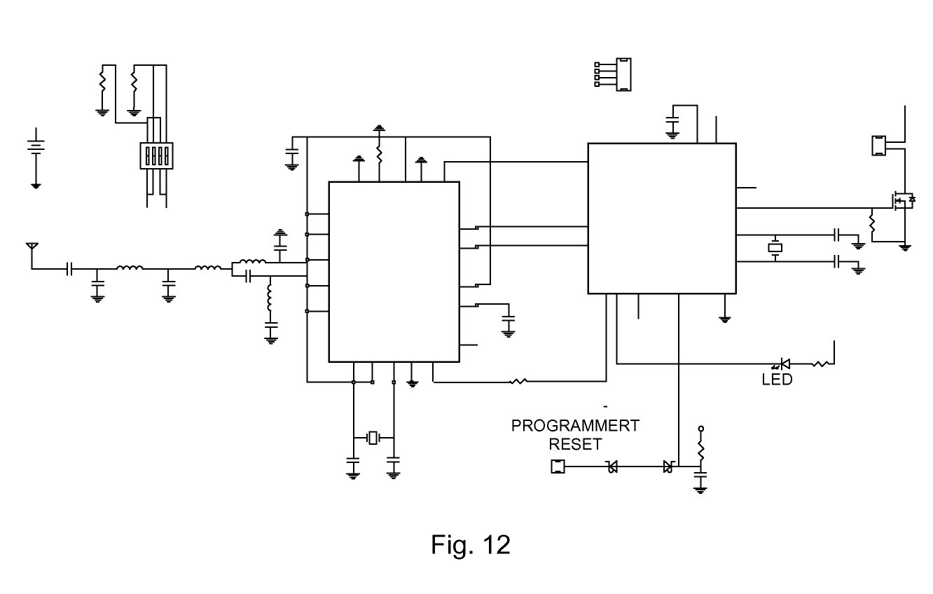

FIG. 12 is a detailed electric circuit diagram of an exemplary embodiment of a remote controlled fluid valve, according to the present invention.

While the invention has been described with respect to a limited number of embodiments, it will be appreciated that many variations, modifications and other applications of the invention may be made.

What is claimed is:

1. A system for controlling a fluid flow comprising:
(a) at least one remote controlled fluid valve said at least one remote controlled fluid valve including:
(i) a gear;
(ii) an engine, for setting said gear in rotational motion;
(iii) a flexible tube; and
(iv) an arms mechanism for pressing on said flexible tube and thus blocks said flexible tube to a fluid flow, wherein said rotational motion is transformed to linear motion by said arms mechanism.

2. The system for controlling a fluid flow of claim 1 further comprising:
(b) at least one pedal unit in active communication with said remote controlled fluid valve, said at least one pedal unit including:
(i) a pedal unit printed circuit board, having a transmitter;
(ii) at least one pedal unit battery; and
(iii) a tact switch operatively connected to said pedal unit printed circuit board, wherein when said tact switch is pressed by a pressing tact force and said pedal unit printed circuit board is transmitting at least one electromagnetic control signal.

3. The system for controlling a fluid flow of claim 2, wherein said at least one pedal unit includes:
(iv) a pressure pad disposed on said tact switch; and
(v) at least one push unit for activating a push force on said pressure pad, wherein when there is no second pressing force above a predetermined value acting on said pressure pad a tact force is removed from said tact switch.

4. The system for controlling a fluid flow of claim 2, wherein said at least one pedal unit further includes:
(iv) a code transmitter; and
(v) a pedal unit microcontroller for receiving data from said tact switch, and from said code transmitter, said pedal unit microcontroller being operatively connected to said code transmitter and operatively connected to said pedal unit printed circuit board.

5. The system for controlling a fluid flow of claim 3, wherein said at least one pedal unit further includes:
(vi) a code transmitter; and
(vii) a pedal unit microcontroller for receiving data from said tact switch, and from said code transmitter, said pedal unit microcontroller being operatively connected to said code transmitter and operatively connected to said pedal unit printed circuit board.

6. The system for controlling a fluid flow of claim 1, wherein said gear of said at least one remote controlled fluid valve further includes:
a first cogwheel;
a first common pivot rigidly connected to said first cogwheel;
a second worm; rigidly connected to said first common pivot;
a second cogwheel for receiving rotational movement from said second worm;
a second common pivot rigidly connected to said second cogwheel; and
a wheel rigidly connected to said second common pivot, wherein said engine has an engine pivot worm for transmitting rotational movement to said first cogwheel.

7. The system for controlling a fluid flow of claim 1, wherein said arms mechanism of said at least one remote controlled fluid valve further includes:
a first pivot connected to said wheel;
a first arm connected to said first pivot;
a second pivot connected to said first arm;
a second arm connected to said second pivot;
a third arm connected to said second pivot;
a fourth pivot connected to said third arm; and
a fourth arm connected to said fourth pivot and rigidly connected to said flexible tube, wherein said arms mechanism has a state of pressing against said flexible tube and a state of non-pressing against said flexible tube.

8. The system for controlling a fluid flow of claim 6, wherein said arms mechanism of said at least one remote controlled fluid valve further includes:
a first pivot connected to said wheel;
a first arm connected to said first pivot;
a second pivot connected to said first arm;
a second arm connected to said second pivot;
a third arm connected to said second pivot;
a fourth pivot connected to said third arm; and
a fourth arm connected to said fourth pivot and rigidly connected to said flexible tube, wherein said arms mechanism has a state of pressing against said flexible tube and a state of non-pressing against said flexible tube state.

9. The system for controlling a fluid flow of claim 8, wherein said at least one remote controlled fluid valve further includes:
(v) a base bridge for providing a base point for generating a third force;
(vi) a third pivot connected to said base bridge and connected to said second arm; and
(vii) a back assembly having a sensor for recognizing an end of a movement of said arms mechanism.

10. The system for controlling a fluid flow of claim 1, wherein said at least one remote controlled fluid valve further includes:
(v) a remote controlled fluid valve printed circuit board having a transceiver;
(vi) a remote controlled fluid valve battery operatively connected to said remote controlled fluid valve printed circuit board;
(vii) a remote controlled fluid valve battery microcontroller operatively connected to said remote controlled fluid valve battery and operatively connected to said remote controlled fluid valve printed circuit board;
(viii) a remote controlled fluid valve battery driver operatively connected to said remote controlled fluid valve battery microcontroller and operatively connected to said engine; and
(ix) a code transceiver, wherein said remote controlled fluid valve printed circuit board is adapted for receiving an electromagnetic control signal.

11. The system for controlling a fluid flow of claim 6, wherein said at least one remote controlled fluid valve further includes:
(v) a remote controlled fluid valve printed circuit board having a transceiver;
(vi) a remote controlled fluid valve battery operatively connected to said remote controlled fluid valve printed circuit board;
(vii) a remote controlled fluid valve battery microcontroller operatively connected to said remote controlled fluid valve battery and operatively connected to said remote controlled fluid valve printed circuit board;
(viii) a remote controlled fluid valve battery driver operatively connected to said remote controlled fluid valve battery microcontroller and operatively connected to said engine; and
(ix) a code transceiver, wherein said remote controlled fluid valve printed circuit board is adapted for receiving an electromagnetic control signal.

12. The system for controlling a fluid flow of claim 7, wherein said at least one remote controlled fluid valve further includes:
(v) a remote controlled fluid valve printed circuit board having a transceiver;
(vi) a remote controlled fluid valve battery operatively connected to said remote controlled fluid valve printed circuit board;
(vii) a remote controlled fluid valve battery microcontroller operatively connected to said remote controlled fluid valve battery and operatively connected to said remote controlled fluid valve printed circuit board;
(viii) a remote controlled fluid valve battery driver operatively connected to said remote controlled fluid valve battery microcontroller and operatively connected to said engine; and
(ix) a code transceiver, wherein said remote controlled fluid valve printed circuit board is adapted for receiving an electromagnetic control signal.

13. The system for controlling a fluid flow of claim 8, wherein said at least one remote controlled fluid valve further includes:
(v) a remote controlled fluid valve printed circuit board having a transceiver;
(vi) a remote controlled fluid valve battery operatively connected to said remote controlled fluid valve printed circuit board;
(vii) a remote controlled fluid valve battery microcontroller operatively connected to said remote controlled fluid valve battery and operatively connected to said remote controlled fluid valve printed circuit board;
(viii) a remote controlled fluid valve battery driver operatively connected to said remote controlled fluid valve battery microcontroller and operatively connected to said engine; and
(ix) a code transceiver, wherein said remote controlled fluid valve printed circuit board is adapted for receiving an electromagnetic control signal.

14. The system for controlling a fluid flow of claim 9, wherein said at least one remote controlled fluid valve further includes:
(v) a remote controlled fluid valve printed circuit board having a transceiver;
(vi) a remote controlled fluid valve battery operatively connected to said remote controlled fluid valve printed circuit board;
(vii) a remote controlled fluid valve battery microcontroller operatively connected to said remote controlled fluid valve battery and operatively connected to said remote controlled fluid valve printed circuit board;
(viii) a remote controlled fluid valve battery driver operatively connected to said remote controlled fluid valve battery microcontroller and operatively connected to said engine; and
(ix) a code transceiver, wherein said remote controlled fluid valve printed circuit board is adapted for receiving an electromagnetic control signal.

15. The system for controlling a fluid flow of claim 1 further comprising:
(b) at least one ray cut operating sub-system, said at least one ray cut operating sub-system including:
(i) a ray transmitter for a continuously transmitting a ray; and
(ii) a ray receiver and communication transmitter.

16. The system for controlling a fluid flow of claim 7 further comprising:
(b) at least one ray cut operating sub-system, said at least one ray cut operating sub-system including:
(i) a ray transmitter for a continuously transmitting a ray; and
(ii) a ray receiver and communication transmitter, wherein receiving after an un-receiving period of time of said ray by said ray receiver and communication transmitter, causing said ray receiver and communication transmitter to transmit a signal, causing said arms mechanism of said at least one remote controlled fluid valve to alternate between said state of pressing against said flexible tube, and said state of non-pressing against said flexible tube state.

17. The system for controlling a fluid flow of claim 14 further comprising:
(b) at least one ray cut operating sub-system, said at least one ray cut operating sub-system including:
(i) a ray transmitter for a continuously transmitting a ray; and
(ii) a ray receiver and communication transmitter, wherein receiving, after a period of time without reception, of said ray by said ray receiver and communication transmitter, causes said ray receiver and communication transmitter to transmit a signal, causing said arms mechanism of said at least one remote controlled fluid valve to alternate between said state of pressing against said flexible tube and said state of non-pressing against said flexible tube.

18. The system for controlling a fluid flow of claim 14 wherein said at least one remote controlled fluid valve further includes:
(viii) a wall, having a form of a cylinder, said cylinder has a longitudinal cross-section of an ellipsoid shape with both ends cut off, including no sharp ends.

19. The system for controlling a fluid flow of claim 17 wherein said at least one remote controlled fluid valve further includes:
(viii) a wall, having a form of a cylinder, said cylinder has a longitudinal cross-section of an ellipsoid shape with both ends cut off, including no sharp ends.

20. The system for controlling a fluid flow of claim 18 comprising:
(a) at least two remote controlled fluid valves.

21. The system for controlling a fluid flow of claim 19 comprising:
(a) at least two remote controlled fluid valves.

22. A system for controlling a fluid flow comprising:
(a) at least one controlled fluid valve including:
(i) a body, said body including a fluid passageway having an inlet, and an outlet;
(ii) a control circuit having an antenna mounted inside said body;
(iii) at least one battery mounted inside said body, said battery being operatively connected to said control circuit;
(iv) an engine mounted inside said body, said engine being operatively connected to said control circuit;
(v) a central axle disposed inside said passageway; and
(vi) a throttle mounted on said central axle inside said passageway wherein said throttle is operatively connected to said engine, and wherein said throttle has an open state and a closed state.

23. The system for controlling a fluid flow of claim 22 further comprising:
(b) at least one ray cut operating sub-system, said at least one ray cut operating sub-system including:
(i) a ray transmitter for a continuously transmitting a ray; and
(ii) a ray receiver and communication transmitter, wherein receiving, after a period of time without any reception, of said ray by said ray receiver and communication transmitter, causes said ray receiver and communication transmitter to transmit a signal, causing said throttle of said controlled fluid valve to alternate between said open state and said closed state.

24. A system for controlling a fluid flow comprising:
(a) at least one controlled fluid valve including:
(i) a body, said body includes a passageway having a passageway inlet and a passageway outlet;
(ii) a passageway opening located inside said body;
(iii) a passageway valve for blocking said passageway opening, wherein said passageway valve has an open state and a closed state;
(iv) a passageway opening spring in contact with said passageway valve;
(v) an inside compartment located inside said body, said inside compartment having an inside compartment space, an inside compartment inlet and an inside compartment outlet;
(vi) a releasing pressure valve located inside said inside compartment;
(vii) a coil located inside said inside compartment;
(viii) a magnet located inside said inside compartment; and
(ix) a spring for releasing pressure located inside said inside compartment, wherein upon receiving a signal said releasing pressure valve moves from said inside compartment inlet, thereby allowing fluid to enter into said inside compartment, and exit through said inside compartment outlet, thus, fluid pressure on said passageway valve is reduced, thereby allowing said passageway opening spring to overcome said fluid pressure on said passageway valve thus shifting said passageway valve to open state.

25. The system for controlling a fluid flow of claim 24 further comprising:
(b) at least one ray cut operating sub-system, said at least one ray cut operating sub-system (401) including:
(i) a ray transmitter for a continuously transmitting a ray; and
(ii) a ray receiver and communication transmitter, wherein receiving, after a period of time without reception, of said ray by said ray receiver and communication transmitter, causing said ray receiver and communication transmitter to transmit a signal, causing said passageway valve of said controlled fluid valve to be in said open state.
